(19) United States
(12) Patent Application Publication
(10) Pub. No.: US 2026/0346512 A1
(43) Pub. Date: Nov. 5, 2026

(54) CONTOURED ARTICLE FORMED FROM A FIBROUS INTERMEDIATE PART USING AT LEAST ONE COATING AND METHODS FOR MAKING THE SAME

(71) Applicant: Simplifyber, Inc., Raleigh, NC (US)

(72) Inventors: Maria Intscher-Owrang, Brooklyn, NY (US); Philip Cohen, Nashville, TN (US); Joseph Miller, Raleigh, NC (US); Juliana Jardim, Raleigh, NC (US)

(21) Appl. No.: 19/665,529

(22) Filed: May 1, 2026

Related U.S. Application Data
(60) Provisional application No. 63/798,307, filed on May 1, 2025.

(51) Int. Cl. B29C 43/04; B29C 43/36; B29C 43/52; B29K 105/00; B29K 105/12

(52) U.S. Cl. CPC B29C 43/04; B29C 43/36; B29C 43/52; B29K 2105/0064; B29K 2105/128

(57) ABSTRACT

The present invention is directed to a solid, fibrous molded part having at least one exterior surface and an interior bounded by at least one exterior surface. The solid, fibrous molded part being comprised of a plurality of fibers, at least one bonding agent and at least one coating material wherein the coating material is present at the interior of the solid, molded fibrous part. The method for making the solid, fibrous molded part includes applying a coating material to a fibrous matrix as an intermediate step prior to the final molding process in order to achieve a more moldable fibrous matrix and a finished good with enhanced or altered physical characteristics due to the time of application and penetration of the coating material into the interior of the fibrous matrix and, accordingly, into the final molded article.

### FIELD OF THE INVENTION

The field of the invention is apparatus and method for molding a two- or three-dimensional unitary article and, more specifically, for molding a two- or three-dimensional unitary soft good, semi-rigid, or rigid article that includes the application of a coating material to a fibrous matrix prior to a final molding step.

### BACKGROUND OF THE INVENTION

The current process for creating soft goods, such as clothing, footwear (e.g., shoe uppers), bags, furniture, medical supplies, cleaning tools and consumables, toys, automotive interior parts, cases and housings for consumer electronics, and other soft goods is often wasteful and includes numerous steps. Within each manufacturing step is a separate, inefficient, labor-intensive process that often requires transport of materials between the steps. Scrap materials (e.g., cloth that is cut but not used) are often simply discarded, adding to the waste in the process. Additionally, raw materials are typically provided in flat shapes and must be formed into the final desired shape, different equipment and processes must frequently be employed when small changes in the final design are implemented, and surface feature and/or texture final design must be added in a secondary operation. There is a need in the industry to be able to form a unitary solid fibrous molded part that has a high-quality appearance, can include intricate contours, shapes and/or surface details, and can exhibit superior strength and durability without the need for expensive, time-consuming and labor-intensive post-forming operations, the use of materials other that are not moldable and/or the use of materials that have low quality appearance.

Even with rigid and semi-rigid goods there is often unnecessary complexity in supply chains due to the fact that surface materials are either too expensive or don’t have the required strength and/or ability to be shaped to form the entire part—so for example, an interior door panel on a vehicle will often be comprised of a surface material bonded to a carrier material that provides the support, so you end up having at least 3 components (surface material, adhesive layer, structural support piece) supplied by 3 different vendors, and logistics in-between to put these components together. Complexity, time and expense would all be reduced by having a material that could be beautiful and high-value in appearance, produced cost-effectively in the desired shape, so that the entire part is comprised of only a single material and element.

One known issue with most nonwoven materials is that, when compared with woven or knit materials, non-wovens are typically not as strong, they are not perceived as beautiful, and they are not as resistant to wear-and-tear as wovens and knits. For this reason, most nonwoven textiles or fiber-based goods are limited to low value, single-use or disposable applications.

It is also known in the art to apply coatings to finished goods after formation of the non-woven, fibrous molded part. The coatings are known to enhance characteristics of the fibrous molded part, such as the appearance of the product and wear resistance. However, the benefits of the application of prior art coatings can be limited due to the coating being applied post-production which can show reduced performance due to limited penetration, coating-substrate interaction, and with additional post-production steps often needed to improve the application and performance of the coating.

These and other shortcomings in the prior art are addressed by the present invention, as disclosed herein.

### SUMMARY OF THE INVENTION

According to one aspect of the present invention, a method for forming a solid, fibrous molded article is provided. The method includes providing a slurry that contains at least an amount of water, plurality of fibers, process additives and binders, and removing at least some of the water from the slurry to produce a fibrous matrix. A coating material is then introduced to the fibrous matrix via a coating process such that the coating material penetrates an outer surface of the fibrous matrix and is present at an interior of the fibrous matrix to create a coated fibrous matrix. The coated fibrous matrix is then placed in a mold or a press having a first mold portion and a second mold portion wherein at least one of the first or second mold portions includes a contour. At least one of heat and pressure is applied to the press such that fiber to fiber bonding or chemical cross-linking of fibers occurs to create a solid, molded fibrous article.

According to another aspect of the present invention, the method above can produce an article that includes a coating material at the interior of the finished product.

One advantage of the present invention is the enhanced structural properties of the molded fibrous matrix due to the introduction of the coating material prior to the final molding process instead of applying the coating after the formation.

Another advantage of the present invention is the final solid, fibrous molded part can have increased wear resistance (e.g., abrasion resistance, weather resistance), increased z-axis strength, enhanced hydrophobicity, resistance to cleaning chemicals, improved processing efficiencies, and better adhesion results when material is combined with other components (e.g., shoe soles).

A further advantage of the present invention is the enhanced ability of the solid, fibrous molded part to retain a molded shape with more fidelity and permanence.

An even further advantage of the present invention is the enhanced ability to improve aesthetics of finished goods via, e.g., including increased depth of color, increased shine and a finished product with a sealed and finished surface that provides a luxurious and high-quality look and feel.

A still further advantage of the present is that this process can reduce processing time, especially post-processing coating time associated with prior art and that can be needed to achieve improved final product characteristics of prior art products.

An even still further advantage is the ability to easily and directly control the level of flexibility and/or rigidity of the resulting material produced within the system, as well as the raw materials used, in order to fine-tune the material to the specific application and desired characteristics. As a result, products can present a range of different performances and behaviors.

These and other advantages will be apparent to one of skill in the art in light of the present disclosure and drawings.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a diagrammatic set up for adding at least some of the desired ingredients of the slurry into a mixer;

FIG. 2 shows a diagrammatic set up for mixing the slurry, providing an amount of a single formula of the slurry into a molding form, and removing fibrous matrix from the molding form;

FIG. 3 shows a three-dimensional fibrous matrix undergoing an immersion coating process;

FIG. 4 shows a three-dimensional fibrous matrix undergoing a spray coating process;

FIG. 5 shows a coated three-dimensional fibrous matrix undergoing a subsequent forming step while still at least partially wet; and

FIG. 6 shows a coated solid, fibrous article (e.g., a shoe upper) after it has been removed from the final forming step and attached to a shoe sole wherein the shoe upper was at least partially formed in the forming step shown in FIG. 5.

### DETAILED DESCRIPTION OF THE INVENTION

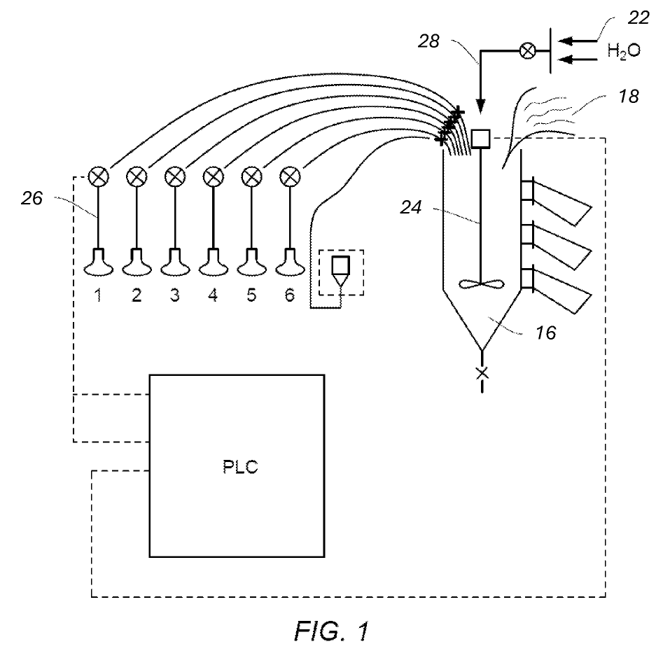

Referring now to FIGS. 1-6, the present invention is an article 10 that is a soft good or part thereof with at least one shaped contour made from a fibrous material. The fibrous material includes a plurality of fibers that are bonded together. The article 10 includes at least one exterior surface 12 and an interior 14 that is bounded by one or more exterior surface. The article is formed from a slurry 16 that is an aqueous dispersion containing at least one type of fiber 18 therein. The article 10 includes coating material 20 that is added at an intermediate step where a fibrous matrix 42 is formed (described infra.) and a coating material 20 is applied in a manner such that the coating material 20 penetrates the exterior surface 12 and is located within the interior 14 of the fibrous matrix and, subsequently, the article 10 after the final forming/molding process has taken place. The addition of the coating material 20 at the intermediate step enhances the moldability and/or physical properties of the fibrous matrix 42 and/or the finished article 10.

Common soft goods that the articles 10 of the present invention can be formed using the methods and apparatus disclosed herein include, but are not limited to, footwear, clothing and various other apparel, bags and various other accessories, automotive interior upholstery and parts, consumer goods, furniture upholstery and parts therefor, and soft medical products. Examples of footwear include, but are not limited to, shoe uppers. Examples of clothing articles include, but are not limited to, shirts, shorts, gowns and other medical clothing, dresses, skirts, pants, socks, vests, sweaters, scarves, hats, gloves, mittens, and undergarments. Examples of bags include, but are not limited to, handbags, purses, backpacks, bookbags, satchels, clutches, travel cases, luggage and toiletry cases. Examples of automotive interior parts include, but are not limited to, interior panels, interior trim, seat covers, floor mats, dashboards and steering wheel covers. Examples of consumer goods include, but are not limited to, laptop/computer housings, soft circuit board coverings, phone cases, soft cleaning products and feminine hygiene products. Examples of furniture upholstery include, but are not limited to, chair and couch coverings, seat and seatbacks, cabinets, table and countertop coverings, pads and wall coverings or panels. Examples of soft medical products include, but are not limited to, bandages and various other coverings, slings, and various other stabilization elements, to include soft goods for internal body use.

The present invention, in some embodiments, is also suitable for the manufacture of solid, molded fibrous articles 10 for use as semi-soft goods or hard goods.

The term “coating” and “coating material” are used interchangeably herein. The terms “coating” and/or “coating material”, as used herein, shall refer to any material that one of skill in the art of solid, fibrous non-woven materials would conventionally understand to be applied to a surface of a finished solid, fibrous non-woven part (i.e., an article 10) for the purpose of decoration, function or both. For example, coating materials applied to a solid, fibrous non-woven article can either improve or modify the properties of the article. Examples of known coating materials 20 include Polyurethane (PU), Polyvinyl Chloride (PVC), Silicone, Acrylic, Polyvinylidene Chloride (PVDC), Ethylene Vinyl Acetate (EVA), Natural Rubber (NR), Synthetic Rubber (SBR).

The slurry 16 can include virgin or recycled natural fibers, semi-synthetic fibers, synthetic fibers or a combination thereof. The slurry 16 may also include binders, and process additives. Natural fibers include, but are not limited to, wood fibers, plant fibers, fungus (e.g., mycelium), and animal fibers. Wood fibers include, but are not limited to, hardwood and/or softwood fibers, bleached and/or unbleached, virgin and/or recycled. Plant-based fibers can include, but are not limited to, cotton, flax, hemp, jute, ramie, bamboo, sisal, abaca, kapok, coir, and general agricultural waste, uncolored or colored, from virgin or recycled sources. Animal fibers can include, but are not limited to, wool, silk, cashmere, alpaca, llama, mohair, yak, camel hair, qiviut, vicuna, angora, and horsehair, uncolored or colored, from virgin or recycled sources. The semi-synthetic fibers can include, but are not limited to, cellulose-based fibers such as rayon, viscose, modal, Tencel, Lyocell, and acetate. Synthetic fibers can include, but are not limited to, polyester, nylon, olefin, spandex/elastane, acrylic, PVC, aramid, microfiber, uncolored or colored, from virgin or recycled sources. Additionally, sustainable synthetic fibers such as, but not limited to, polylactic acid (PLA) fibers and polyhydroxyalkanoates (PHA) fibers can be used. One or more fiber types are added and any other ingredient, such as, but not limited to, natural, biobased and/or synthetic molecules/polymers, coating materials 20, and additives can be added to the material to be used, either before formation (while in a liquid state), after the material is dried or after the item (or part of the item) is formed. Biobased molecules/polymers can be added as binding agents and/or retention agents in order to enhance or alter the wet and dry strength of the solid fibrous molded part 14. These biobased molecules/polymers include, but are not limited to, chitosan, starches, ionic starches, cellulosic materials, natural rubber latex, collagen, waxes, gelatine, alginate, polylactic acid, polyglycolic acid, and polyhydroxyalkanoates. The cellulosic materials can include, but are not limited to carboxymethylcellulose, nanofibrillated cellulose, and nanocellulose. Additionally, synthetic molecules/polymers and synthetic molecules/polymers with a certain amount of biobased carbon can be used in the materials, such as, but not limited to, waxes, rubbers, polyurethane emulsions, thermoplastic materials, and resins in order to improve mechanical properties. One suitable slurry 16 is disclosed in U.S. Patent Application Serial Number 17/466,792, the disclosure of which is hereby incorporated by reference. The slurry 16 can be created by combining the fibers 18, water 22 and any other ingredients (e.g., solvent(s)) desired into a mixer 24. In some embodiments, water can be substituted for another liquid, such as an, but not limited to, organic solvent.

In some embodiments, although not shown in the figures, the article may be a unitary item that is made from more than one slurry 16 wherein the slurries have at least one materially different characteristic from the other slurry formula(s). Additionally, the slurry 16 may include one or more coating materials 20 directly added therein, as well.

FIG. 1 shows an exemplary set up where a series of ingredient sources 26 are in communication with the mixer that enable an amount of various ingredients to be provided (e.g., pumped, injected, or gravity fed) into the mixer 24, as desired. In the example shown, up to six ingredient sources are provided. In addition, a water (or other liquid) source 28 and a source for fibers 30 are also provided for adding desired amounts of fiber 18 into the mixer 24. Once in the mixer 24, the ingredients are mixed, generally until all ingredients are fully mixed and/or dispersed, and the slurry 16 takes on the form of a mixture, foam, or a homogeneous fiber dispersion. An example of the aforementioned slurry 16 may contain, but is not limited to, the following content: water (20-99.99%), fibers (0.0075-60%), other additives (0.0025-20%).

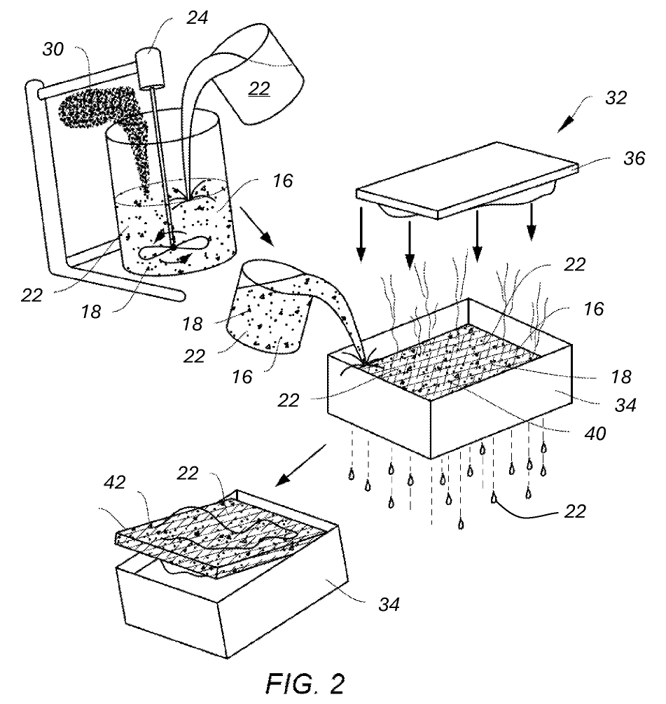

Referring now to FIG. 2, once the desired ingredients are combined and mixed in the mixer 24, and the mixed slurry 16 can then be poured, pumped, injected or gravity fed into a molding form 32. Notably, FIG. 2 is provided as an exemplary figure depicting this process with a single formula. In the embodiment shown, the molding form includes a first mold portion 34 and a second mold portion 36. The first mold portion 34 may include a screen 40 with openings that generally allow water 22 (or other liquid) to drain therethrough but retains the solid fibers 18. The second mold portion 36 may include a desired two- or three-dimensional shape that is at least partially imparted onto the fibrous matrix 42 (i.e., an intermediate part formed from the at least partially shaped and/or dehydrated slurry 16 after the slurry 16 has been at least partially formed in the molding form and, optionally, at least some liquid has been removed from the slurry 16). Although not required, the second mold portion 36 may optionally also include a plurality of holes (e.g., a screen). In other embodiments, a second mold portion 36 may not be necessary.

Optionally, the screen 40 in the first mold portion may also have a two- or three-dimensional shape that is at least partially imparted onto the fibrous matrix 42. As the water 22 (or other liquid being utilized) is removed from the slurry 16 through the screen, heat and/or pressure may be applied to achieve fiber to fiber bonding, polymer to polymer bonding, and/or polymer to fiber bonding, as well as chemical cross-linking. In some embodiments, at least some of the water 22 (or other liquid being utilized) is removed from the slurry 16 forming the fibrous matrix 42. In other embodiments, although not shown, it may be desirable to retain (at least temporarily) substantially all of the water 22 (or other liquid being utilized) depending on the intended final design.

While still at least partially wet, the fibrous matrix 42 can optionally be removed from the mold form 32. The fibrous matrix 42 is then preferably dewatered and rinsed to remove unreacted chemicals, excess liquids, and/or other excesses of process additives yielding a fibrous matrix 42 that is either two- or three dimensional. Then, the still-wet, partially dried or completely dried two- or three-dimensional fibrous matrix 42 then undergoes a coating process.

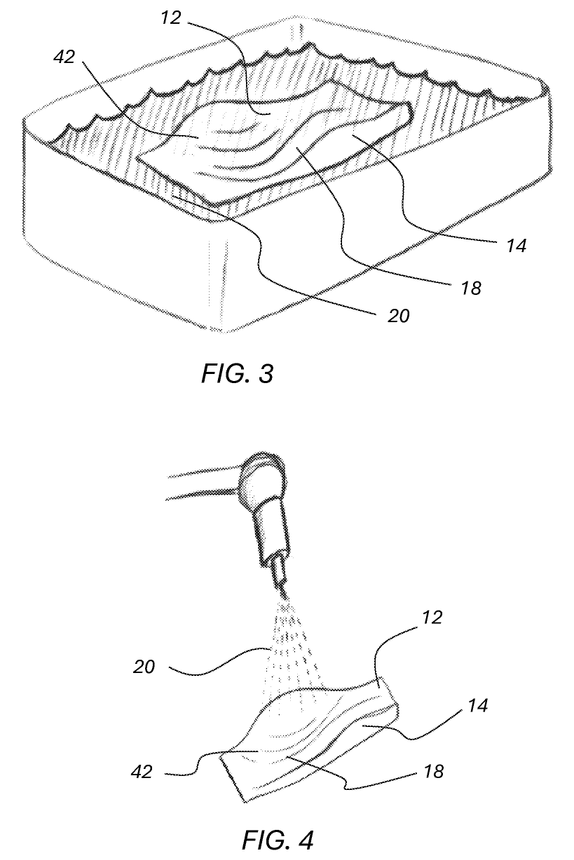

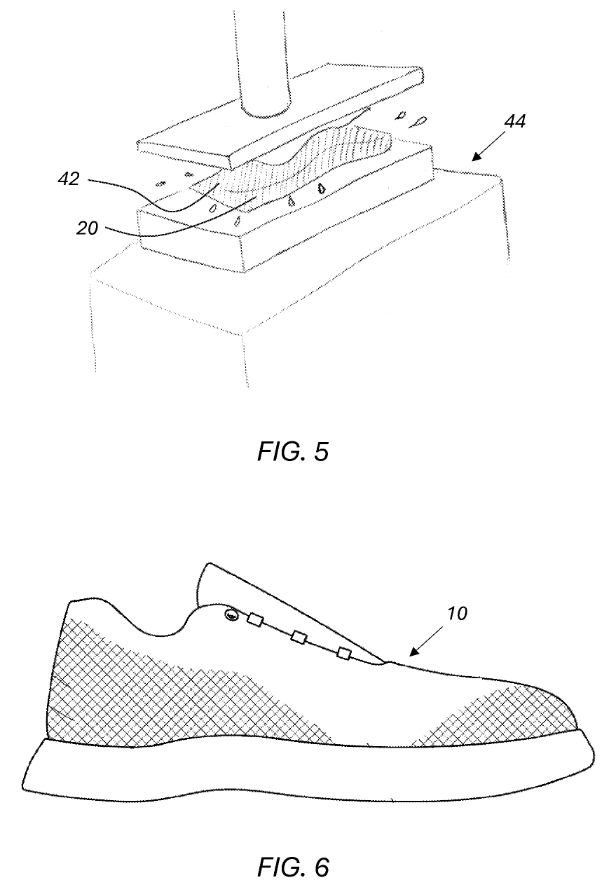

Referring now to FIGS. 3 and 4, the fibrous matrix 42 can be coated via direct (or knife) coating, immersion coating, direct roll coating, vapor deposition, transfer coating, or spray coating in order to partially or fully saturate the fibrous matrix in the coating material. FIG. 4 illustrates bath or immersion coating where the still-wet fibrous matrix is immersed in a bath 44 of coating materials 20 such that the coating material 20 can intermingle with the fibrous matrix 42, penetrating the exterior surface 12 of the fibrous matrix 42 such that the coating material 20 is present in the interior 14 of the fibrous matrix 42. FIG. 5 illustrates a spray coating technique that similarly applies a coating material 20 to at least some of the fibrous matrix 42 such that, in similar fashion to the immersion coating process, the coating material 20 can intermingle with the fibrous matrix 42, penetrating the exterior surface 12 such that the coating material 20 is present in the interior 14 of the fibrous matrix 42.

One of skill in the art would recognize that the two above coating techniques are not limiting and that other known coating techniques can be used to coat the fibrous matrix 42 in order to achieve the same or substantially similar results without departing from the spirit or scope of the invention. For example, direct coating, roll coating and any other coatings methods could be utilized. Additionally, the fibrous matrix 42 can be coated with a plurality of coating materials 42 simultaneously or in a series of coating processes.

In some embodiments, the coating material 20 can be located substantially throughout the entire interior 14 of the fibrous matrix 42 and, subsequently the final article 10 such that the coating material 42 is present on one or more exterior surface(s), and/or has penetrated the exterior surface 12 and is located within the interior 14. In some embodiments, the coating material 20 is located throughout the material with a certain distribution. In other embodiments, the coating material 20 can be found in any other reasonable concentrations and/or combinations of coating material location(s) of the fibrous matrix 42 and, subsequently, the final article 10.

Suitable coating materials 20 include, but are not limited, to the following Polyurethane (PU), Polyvinyl Chloride (PVC), Polytetrafluoroethylene (PTFE), Silicone, Acrylic, Polyvinylidene Chloride (PVDC), Ethylene Vinyl Acetate (EVA), Natural Rubber (NR), Synthetic Rubber (SBR), Waxes and/or Fatty Acids, Fiber, Microfiber and/or Nanofiber; and/or composite or hybrid coating types. These coating formulations can be synthetic, bio-based, or all natural and may include additives, to enhance coating stability and durability, processability, efficiency, and ultimately textile performance. These additives may be, but not limited to, UV stabilizers, heat stabilizers, conductivity modifiers, strength modifiers, permeability modifiers, flame retardant, antimicrobials, and antioxidants.

Benefits of coating the still-wet or partially-wet fibrous matrix 42 can include enhancing and/or altering the moldability and/or structural properties of the resulting molded article 10. For example, the final soft good 10 formed can be stronger and/or have a longer life through enhanced wear resistance in embodiments where a coating material is applied prior to the final molding/forming step. These enhanced and/or altered properties can include, but are not limited to: increased z-axis strength, abrasion resistance, weather resistance, enhanced hydrophobicity, resistance to cleaning chemicals, improved processing efficiencies, better adhesion results when material is combined with other components (like shoe soles) and the ability to retain a molded shape with more fidelity and permanence. There can also be aesthetic enhancements or alterations, including increased perceived depth of color, increased shine and ultimately creating a more sealed and finished surface that yields a luxurious and high-quality look and feel.

After the coating step, the fibrous matrix 42 with the coating material 20 now applied can either be partially or fully dehydrated again before molding or, preferably, the coated fibrous matrix 42 is immediately transferred into a molding system 44 for the final shape formation. Additionally, in one example, in embodiments where the coated fibrous matrix 42 is dried, the fibrous matrix 42 can optionally be re-wet and then transferred to a molding system 44 for final shape formation. The final molded shape can be either two- or three-dimensional shape although it is preferable for the final molded shape of the article 10 includes at least one contour.

Referring now to FIG. 5, the coated fibrous matrix 42 is positioned in the final forming step while still at least partially wet. This forming step involves pressure and heat, where moisture is partially or totally removed from the material and the final properties are enhanced or altered. Although a forming operation is shown in FIG. 5, any suitable process can be utilized.

In operation, a slurry 16 including at least water 22 (or other liquid being utilized), a single type of fiber 18 or a plurality of fiber types, and additives are provided to a mixer 24. The components are mixed until the slurry 16 is a mixture, foam, or a homogeneous suspension.

The slurry 16 is then added to the molding form 32. None, some, or most of the liquid (depending on final product material) from the slurry 16 is removed by, e.g., draining and/or drying, effectively dehydrating the substance during the process of converting the slurry 16 to a fibrous matrix 42.

The still-wet, partially dried or dried fibrous matrix 42 is then coated with a coating material 20 such that the coating material 20 intermingles with the fibrous matrix 42, such that the coating material is on one or both surface(s), and/or has penetrated the exterior surface and is located within the interior fibrous matrix 42, and/or is located throughout the fibrous matrix with a certain distribution, and/or any other reasonable combinations of coating location of the fibrous matrix 42.

The coated fibrous matrix 42 is then optionally dehydrated a second time and then the coated fibrous matrix 42 is placed into a molding system 44 while still wet or partially wet.

During the final molding process, heat and/or pressure can be applied to the mold form to further eliminate water 22 (or other liquid being utilized) from the coated fibrous matrix 42 and achieve, e.g., fiber to fiber bonding, polymer to polymer bonding, and polymer to fiber bonding, as well as chemical cross-linking such that the resulting article is a solid fibrous molded part 46 such that the coating material is on one or both surface(s), and/or has penetrated the exterior surface and is located within the interior, and/or is located throughout the material with a certain distribution, and/or any other reasonable combinations of coating location of the fibrous matrix of the article.

In some embodiments, the solid fibrous molded part 46 that is removed from the molding system 44 is the final article 10 that can be used as a soft good, semi-soft good, hard good or part thereof.

In other embodiments where the final desired shape or properties of the article 10 are different from the solid fibrous molded part 46 removed from the molding system 44, the solid fibrous molded part 46 is then formed, pressed (not shown) or otherwise shaped, cut or altered into the final desired article with the desired final shape or properties 10 (see e.g., FIG. 6). In some embodiments, the article 10 may be affixed to additional items (e.g., shoe sole). Although a shoe is shown in FIG. 6, one of skill in the art would recognize that this is non-limiting and the above-described process can be utilized to create numerous types of soft goods or parts therefore.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. An article, comprising:
a solid, fibrous molded part having at least one exterior surface and an interior bounded by the at least one exterior surface, the fibrous molded part being comprised of a plurality of fibers, at least one bonding agent and at least one coating material;
wherein the solid, fibrous molded part includes at least some fiber-to-fiber bonding, polymer to polymer bonding, and/or polymer to fiber bonding; and
wherein the coating material is present at the interior of the solid, molded fibrous part.

2. The article of claim 1 wherein the coating material is located throughout the article.

3. The article of claim 1 wherein the coating material is at a first concentration in one location within the interior of the article and a second concentration at a second location within the interior of the article.

4. The article of claim 1 wherein the coating material is located on substantially the exterior surface of the article.

5. The article of claim 1, wherein the coating material can be synthetic, bio-based, or all natural and include, but are not limited to, at least one of Polyurethane (PU), Polyvinyl Chloride (PVC), Polytetrafluoroethylene (PTFE), Silicone, Acrylic, Polyvinylidene Chloride (PVDC), Ethylene Vinyl Acetate (EVA), Natural Rubber (NR), Synthetic Rubber (SBR), Waxes and/or Fatty Acids, Fiber, Microfiber and/or Nanofiber; and/or composite or hybrid coating types.

6. The article of claim 5, wherein the coating material include an additive selected from one of a UV stabilizer, heat stabilizer, conductivity modifier, strength modifier, permeability modifier, flame retardant, antimicrobial, and antioxidant.

7. The article of claim 1, wherein the article includes at least one two- or three-dimensional contour.

8. A method for forming a solid, fibrous molded article, comprising:
providing a slurry that contains at least an amount of liquid and a plurality of fibers;
removing at least some of the liquid from the slurry to produce a fibrous matrix;
applying a coating material to the fibrous matrix such that the coating material penetrates an outer surface of the fibrous matrix and is present at an interior of the fibrous matrix to create a coated fibrous matrix;
placing the coated fibrous matrix in a press having at least a first mold portion;
applying at least one of heat and pressure fibrous matrix in the first mold portion such that fiber to fiber bonding or chemical cross-linking of fibers occurs is achieved and creates a solid, molded fibrous article that includes at least some coating material at an interior of the solid, molded fibrous article; and
removing the solid, molded fibrous article from the at least first mold portion.

9. The method of claim 8 wherein the slurry includes at least an amount of coating material.

10. The method of claim 8 wherein the coating material is applied to the fibrous matrix in a bath immersion process.

11. The method of claim 8 wherein the coating material is applied to the fibrous matrix in a spray coating process.

12. The method of claim 8 wherein the coating material coating material can be synthetic, bio-based, or all natural and include, but are not limited to, at least one of Polyurethane (PU), Polyvinyl Chloride (PVC), Polytetrafluoroethylene (PTFE), Silicone, Acrylic, Polyvinylidene Chloride (PVDC), Ethylene Vinyl Acetate (EVA), Natural Rubber (NR), Synthetic Rubber (SBR), Waxes and/or Fatty Acids, Fiber, Microfiber and/or Nanofiber; and/or composite or hybrid coating types.

13. The method of claim 12 wherein the coating material includes an additive selected from one of a UV stabilizer, heat stabilizer, conductivity modifier, strength modifier, permeability modifier, flame retardant, antimicrobial, and antioxidant.

14. The method of claim 8 including at least one of the additional steps of removing liquid and/or rinsing the fibrous matrix to remove unreacted chemicals, excess liquids, and/or excess process additives prior to the applying of the coating material to the fibrous matrix.

15. The method of claim 8 wherein the press includes a second mold portion that works in complementary fashion with the first mold portion.

16. The method of claim 15 wherein at least one of the first and second mold portions defines a two- or three-dimensional contour that is imparted on the solid, molded fibrous article.

17. The method of claim 8 including the additional step wherein the fibrous matrix is at least partially dried after the coating material has been applied thereon.

18. The method of claim 17 wherein the fibrous matrix is re-wetted after the fibrous matrix with the coating material applied thereon has been dried and before the fibrous matrix with the coating material applied thereon has been placed in the press.

19. The method of claim 8 including an additional step of applying a second coating material to the fibrous matrix after the first coating material has been applied to the fibrous matrix and before the fibrous matrix is placed in the first mold portion.

20. The method of claim 19 wherein the second coating material and the coating material are the same.
